(19) United States
(12) Patent Application Publication
(10) Pub. No.: US 2011/0201264 A1
(43) Pub. Date: Aug. 18, 2011

(54) Passive Heat Recovery & Ventilation System

(76) Inventor: Thor Hendrickson, London (GB)

(21) Appl. No.: 12/920,103

(22) PCT Filed: Feb. 27, 2009
(86) PCT No.: PCT/GB09/00570

§ 371 Date: Dec. 27, 2010

(30) Foreign Application Priority Data
Feb. 28, 2008 (GB) 0803674.1

(51) Int. Cl. F24F 7/007; B23P 17/00

(52) U.S. Cl. 454/253; 454/237; 29/401.1; 454/338

(57) ABSTRACT

In order to make use of disused chimneys within residences, a passive heat recovery and ventilation system is fitted within a chimney of a house, the system including inlet and outlet flow ducts fitted within the chimney flue, and extending to the chimney top, and a passive heat recovery device (2) located at the chimney top including a heat exchanger part (6) located in the chimney flue and having air inlet and air outlet ports (24, 26) communicating with the flow ducts, and including an air flow part (4) positioned on top of the chimney which replaces the chimney pot, and which exhausts stale air and draws in ambient air. The air flow part includes a turbine ventilator (18) for drawing out stale air, and a circular array of louvred air inlets (11, 12) for permitting inflow of fresh air.

### FIELD OF THE INVENTION

The present invention relates to a passive heat recovery and ventilation system, primarily for residential purposes.

### BACKGROUND ART

A wind driven passive heat recovery ventilator incorporated into living accommodation is disclosed in GB-A-2374661. It includes a rotatable air inlet/outlet head protruding through the roof, which is turned to face the wind by means of a wind vane. A heat exchanger within the building heats incoming air from the heat of exhausting air. Such a system has been incorporated into practical living accommodation, for example BedZED which is described in various publications, see for example:

http://en.wikipedia.org/wiki/BedZED.

BedZED includes rotatable wind cowls mounted on special purpose base units installed on the roof of a building. The building does not lose heat like conventional buildings because the building is designed to be airtight. Air can only move in and out through the wind cowls on the roof. Cool air coming in replaces warm air going out (the stack effect) and the air currents are separated within a heat exchanger. BedZED is a specially constructed building, and is not adapted for use in existing homes.

Another system for new build homes is disclosed in DE-A-1982640, wherein a so-called chimney, which is not a chimney in the traditional sense, comprises a specially constructed shaft, which acts as a bus to interconnect the energy technology of the building. Such “chimney” includes a heat exchanger and electric fan ventilation box.

Traditionally, homes, houses and other buildings have been constructed with a chimney, the term chimney, for the purposes of this specification, being intended to include a fireplace, chimney flue leading to the top of the chimney, where the is located a chimney pot. This traditional construction is not concerned with passive heat recovery issues. In a typical UK home 20% of all energy expenditure is from air leaks and required ventilation. Roughly, very much depending on the home, 7% of all household energy use is for required ventilation. For existing homes, there are fan driven products which act as heat recovery ventilators—see for example http://www.fantech.net/shr.pdf. The fan driven products consume a small amount of electricity all of the time. Because electricity is dirty in comparison to natural gas, the CO2 emissions for fan driven units may actually be worse than without.

A system has been proposed making use of an existing chimney system in US Patent Application No. US 2003/0121513, which employs a fireplace as an element of the ventilation system. Electric blowers located at the fireplace force out exhaust air, and draw in fresh air. A separate ventilation channel conveys outdoor ambient air into the building interior.

### SUMMARY OF THE INVENTION

It is an object of the invention to provide a passive heating and ventilation system for fitting within an existing home having a traditional chimney.

In a first aspect, the invention provides a method of converting an existing chimney of a building into a passive heat recovery and ventilator system, the method comprising:
providing a fresh air outlet in the chimney flue and a stale air inlet in the chimney flue,
inserting first and second ducts within the chimney flue, the first duct extending from the fresh air outlet to the chimney top, and the second duct extending from the stale air inlet to the chimney top,
inserting a passive heat exchanger means in the chimney top and connected with said first and second ducts for transferring heat from stale outgoing air to fresh incoming air, and positioning an air flow means on top of the chimney and communicating with the heat exchanger for exhausting stale air and drawing in ambient air.

The present invention in a second aspect provides a passive heat recovery system fitted within a chimney of a building, the system including inlet and outlet flow ducts fitted within the chimney flue, and extending to the chimney top, and a heat recovery device located at the chimney top including a heat exchanger part located in the chimney flue and having air inlet and air outlet ports communicating with said flow ducts, and including an air flow part positioned on top of the chimney, for exhausting stale air and for drawing in ambient air.

The concept of the invention is to provide a small device, for residential applications, which is designed to fit within disused chimneys of existing houses. The device may be unitary, or formed as two parts which are connected together to form a single unit. The unit has a similar envelope to a chimney pot. Chimney pots for residences tend to be of a similar diameter, commonly between 20 and 30 cm, and communicating with a square chimney flue. The present invention is not limited to any specific dimension, but may be of any size, but however corresponding to the dimensions of the existing chimney. Having a chimney pot sized unit will minimize the need for structural reinforcement and potentially allow for installation on listed buildings. Planning permission may also be straight forward.

The preferred unit includes a cylindrical air inlet/outlet part to be positioned on top of the chimney and replacing the conventional chimney pot. The air inlet comprises a manifold of cylindrical louvred air inlets extending around the periphery of the unit, so as to be responsive to air currents or wind from any direction. The air outlet preferably extends axially to the top of the unit. The air outlet may include a manifold of cylindrical louvred air outlets extending around the periphery of the unit, so that air can flow out regardless of wind direction.

However, in a particularly preferred form, the manifold of cylindrical louvred air outlets comprising the air outlet is replaced by a turbine ventilator. Turbine ventilators are known devices—see for example http://www.atco.co.th/., and are wind driven devices with a large number of overlapping vane or scoop elements which rotate under wind pressure and operate to create a flow of air. For the purposes of the present invention, the term “turbine rotator” is intended to include all such devices, including turbine ventilators, Savonius turbines, Flettner ventilators, etc., that is wind driven devices having a plurality of vane or scoop elements which rotate under wind pressure and operate to create a flow of air.

In the present invention, the turbine rotator acts, when rotated by wind to draw stale air out of the air outlet. Importantly, since wind flow is an irregular phenomenon, with fluctuations occurring over a period of the order of seconds, the turbine rotator is beneficial, since it continues to operate by reason of its inertia in periods of lack of wind, thereby creating a more reliable operation than prior art devices which use wind cowls, vanes etc.

In a third aspect, the present invention provides a passive heat recovery and ventilation device for a passive heat recovery system fitted within a chimney of a building, the device including a heat exchanger part being dimensioned to fit within a chimney flue at the chimney top, and the device including an air flow part for positioning on top of the chimney, which includes an air outlet for exhausting stale air and an air inlet for drawing in fresh ambient air, wherein said air inlet comprises a plurality of louvred air inlets extending around the periphery of the airflow part, and communicating with an interior plenum, and said air outlet includes a turbine rotator mounted at the top of the air flow part,

said air inlet and air outlet communicating with said heat exchanger part for transfer of heat between outlet and inlet air flows, and said heat exchanger part having air flow ports for connection to air flow ducts fitted within the chimney flue.

Further, the turbine ventilator may be arranged to drive a fan in the air inlet duct so as to boost the pressure of air inflow. This pressure boost will be more constant than the irregular inflow pressure created by external wind acting on the louvers of the air inlet, since the combination of turbine rotator for stale air and fan for inlet air acts as a flywheel or smoothing capacitor, and continues to operate by reason of its inertia in periods of lack of wind, thereby creating a more reliable operation. This therefore is a further advantage of this form of the invention.

It is known to combine a turbine ventilator with a fan to improve the evacuation of stale air, see for example the turbo fan vent described in U.S. Pat. No. 4,641,571. However it has not been previously proposed to combine a turbine ventilator with a fan, which act respectively on oppositely directed air flows.

In a fourth aspect the present invention provides a ventilator device for an enclosed space, and including an air flow part having an exhaust flow path for exhausting stale air and an inlet flow path for drawing in ambient air, wherein the exhaust air flow path includes a turbine rotator, for positioning externally of the enclosed space, and arranged to draw out exhaust air under the influence of external wind, and wherein the turbine rotator is arranged to drive a fan located in the air inlet flow path, for boosting the pressure of the inflow of ambient air.

Said fan may be of a centrifugal type, axial flow type, or mixed centrifugal/axial flow type. A Mixed flow fan, as the name implies, is a cross between a centrifugal and an axial fan. The advantages of a centrifugal fan and a mixed flow fan are that they may have similar flow characteristics to a turbine ventilator, and that they respond to air being driven into only one part of the fan from the louvers (that is the part exposed to wind flow), centrifugal and mixed flow fans acting like each blade is separate. The problem with using a centrifugal fan is that the output flow is radial and it preferably ought to be axial. Since there is limited radial space, an axial fan may be used; and this reduces manufacturing costs. For mixed flow fans, the benefits are

1—Similar flow characteristics to a turbine ventilator (this makes it easier to balance the flow given a variable speed)
2—Axial flow
3—Higher pressure than an axial fan
4—Fairly insensitive to turbulence and variance in the input flow.

The preferred ventilator device of the invention also includes a heat exchanger device, located in the chimney flue, extending from the air flow part and terminating in air inlet and air outlet ports. The air inlet and outlet ports are coupled to respective inlet and outlet ducts that are mounted within the chimney flue and which extend to appropriate air inlets and outlets located within the home. The heat exchanger device functions to warm incoming air with the heat of outgoing air. Extractor fans may be located in the air inlet and/or outlet within the home to assist flow; nevertheless, the system of the invention remains a passive heat recovery and ventilation system.

Installation is similar to lining an old chimney and installing a new chimney pot. The upgrade thus can be done in one day, requires only repair of existing structures and does not require a new hole in the roof. Importantly, in many jobs, no scaffolding would be required. While not a trivial cost, the cost will be low by construct standards. By being air driven, there is also no need for an electrician. As only one team need be involved, the problems of subcontractors are minimized and the installation really can be done in a reliable time frame.

It is estimated the present invention may save roughly 5% of the average energy consumption of a UK home simply be replacing trickle vents and air bricks. By more thoroughly sealing the home, a further 5% to 10% of energy consumption could be reduced. While weatherproofing alone would be responsible for the further saving, having a heat recovery ventilator in accordance with the invention would encourage homeowners to weatherproof their homes as weatherproofing would not contribute to damp or a feeling of stuffiness.

### BRIEF DESCRIPTION OF THE DRAWINGS

A preferred embodiment of the invention will now be described with reference to the accompanying drawings, wherein:

FIG. 1 is a perspective view of a preferred passive heat recovery ventilator device according to the present invention;

FIGS. 2 to 6 are schematic views illustrating the installation of the preferred passive heat recovery system in a disused chimney of a house, in accordance with the invention;

FIG. 7 is a cross-sectional view of the device of FIG. 1;

FIG. 8 is a perspective view of the lower heat exchanger part of the two-part device;

FIG. 9 is a perspective view of the upper air-flow part of the two-part device;

FIG. 10 is a perspective view of a fan assembly of the upper air-flow part, comprising turbine ventilator and centrifugal fan;

FIG. 11 is a plan view of the centrifugal fan of FIG. 10; and

FIG. 12 is a perspective view of an inner cowl frame of the upper air-flow part of the two-part device.

### DESCRIPTION OF THE PREFERRED EMBODIMENT

In a preferred embodiment, two ducts are fitted inside a disused chimney to allow for fresh air to enter into a building and stale air to be extracted from the building. The two flows are passed through a counter-flow heat exchanger mounted at the chimney top. The fresh air recovers heat from the stale air, thus reducing heating energy requirements while providing fresh air for ventilation. In air-conditioned situations, the fresh air will transfer heat to the stale air to reduce cooling energy requirements while providing fresh air. Fresh air enters and stale air exits the chimney through a wind flow device fitted on the top of the chimney. Typically, the unit will replace an existing chimney pot or cap. The wind flow device uses louvred deflectors and the natural energy of the wind to force fresh air into the mechanism. The louvers are fixed and direct wind coming from any horizontal direction into the mechanism. A combination of natural wind energy and the stack effect (where hot air rises) extracts the stale air. Wind is arranged to drive a turbine ventilator to create an upward flow. The upward flow creates a lower pressure area to draw out the stale air. Where needed a wind driven or electric propeller can be fitted to improve flow through the system.

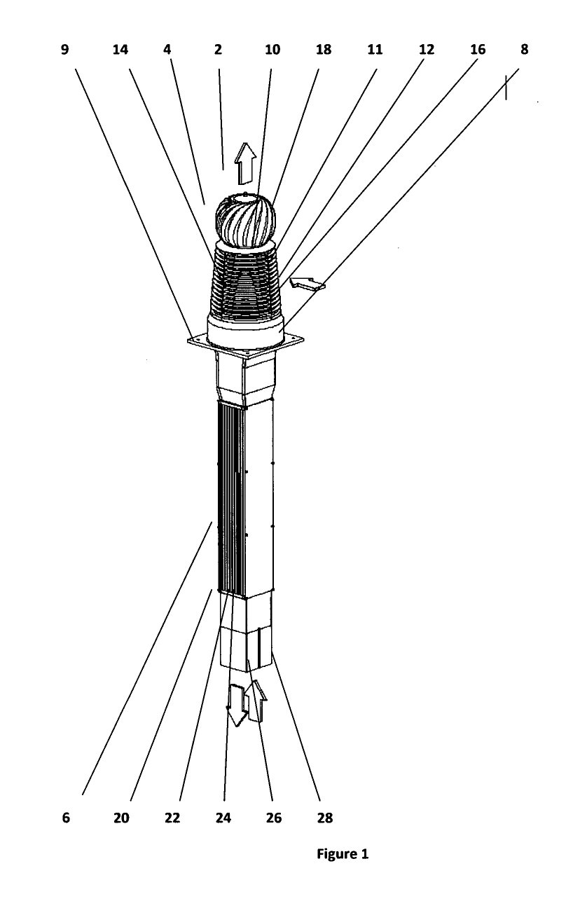

Referring to FIG. 1, heat recovery device 2 is of elongate form with a cylindrical upper module forming an air flow part 4 and a lower part forming a heat exchanger 6. The device has an outer casing 8 of steel or plastic. The two parts 4, 6 are separated by a flange assembly 9.

Air flow part 4 include a cylindrical casing part 10 having vertical columns of louvers 11 providing arcuate apertures 12 spaced around the periphery of the casing, with adjacent columns separated by vertical wall sections 14. The space within the casing comprises a fresh air plenum 16. Since air inlets 12 extend around the entire periphery of the casing, air flow or wind from any direction will flow directly into the air inlets and enter the plenum 16. Louvers 11 are downwardly angled, and create a pressure differential for incoming air.

A stale air outlet flow path extends from heat exchanger 6 axially through airflow module 4 to the top of casing 10 and terminates in a turbine ventilator 18.

Heat exchanger device 6 includes a stack of parallel plates 20, of thin metal or plastic, mounted within casing 8. The upper ends of plates 20 are coupled to stale air outlet turbine ventilator 18 and fresh air plenum 16 at 21 so that spaces 22 between adjacent plates form flow paths for outgoing stale air. Interleaved spaces 24 between adjacent plates form flow paths for incoming fresh air, and are coupled to plenum 16. Heat transfer occurs between the air flows by heat conduction through the plates.

The lower ends of the plates are coupled to stale air inlet port 28 and fresh air outlet port 26. Spaces 24 communicate with port 26 and spaces 22 communicate with port 28.

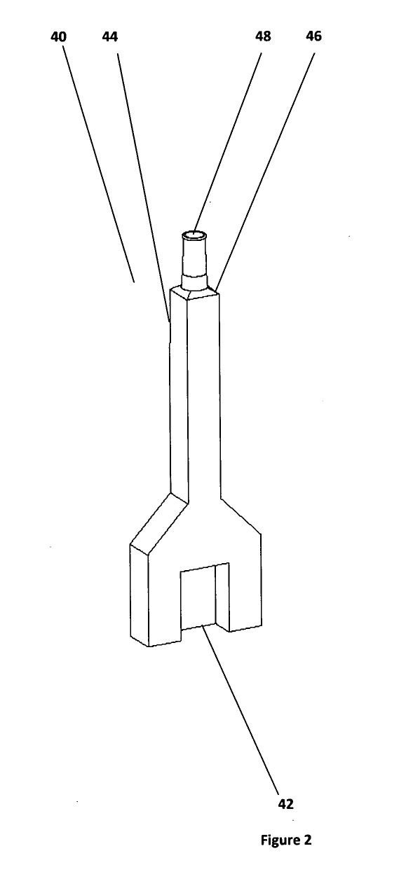

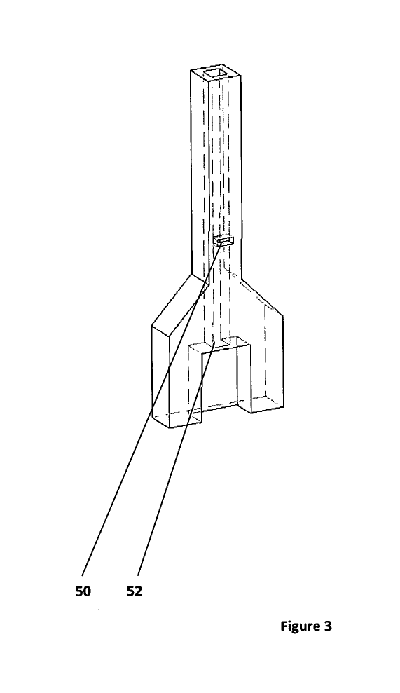

Referring now to FIGS. 2 to 6, the preferred method of installing a passive heat recovery system will be described. In FIG. 2, a chimney 40 in a residence is brick-built, and comprises a fire place 42 having a flue 44 extending to a chimney top 46, having a chimney pot 48. In order to convert this chimney to a heat recovery ventilator system, a first step is shown in FIG. 3 wherein the chimney pot is removed together with surrounding mortar, and the chimney is swept if necessary. A channel 50 is cut into the flue for forming a stale air vent. A channel 52 is cut into the fireplace for fresh air; alternatively an existing air aperture to the chimney flue is adapted as a fresh air vent, and existing fireplace accessories are removed.

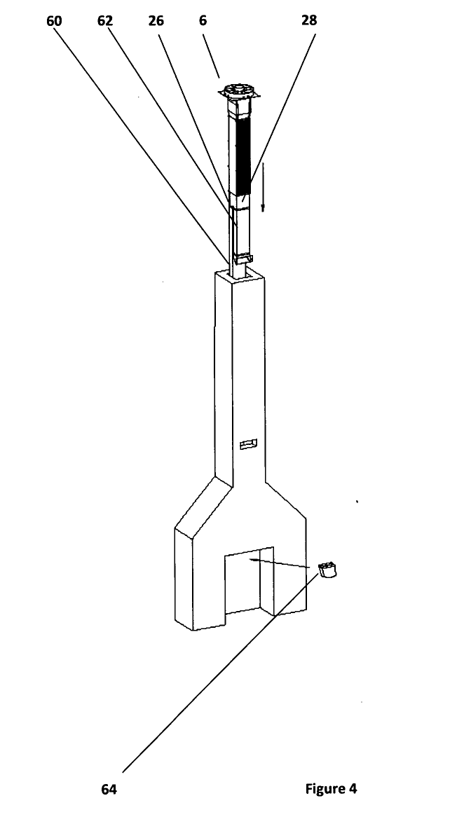

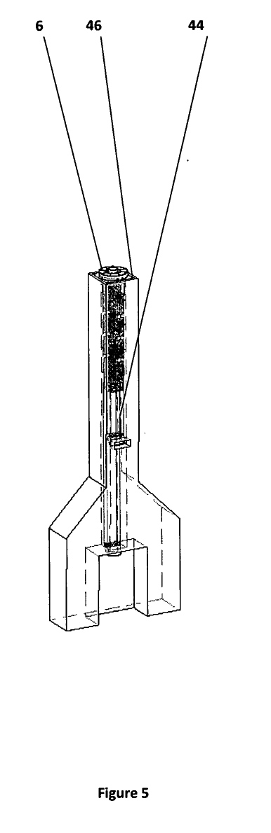

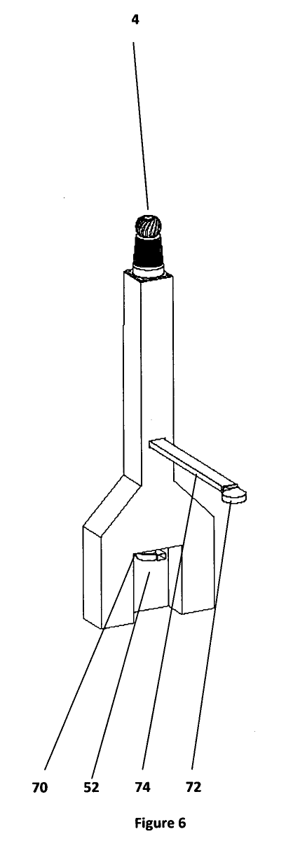

In FIGS. 4 and 5, vertical metal ducts 60, 62 are positioned within the chimney flue and extend to the heat exchanger at the chimney top. A ducting end piece 64 is positioned within the fireplace 42. At the chimney top 46, heat exchanger 6 is inserted into the chimney flue 44, and ports 26 and 28 are inserted into ducts 64, 66. Connection is made as a force fit, but some form of bonding may be employed. As shown in FIG. 6, the air flow module 4 is then attached to heat exchanger 6, and located on the chimney top. The heat exchanger and the air flow part are then secured to one another and fixed in position by flange assembly 9, as described below.

In modifications, as shown in FIG. 6, an air flow inlet blower fan 70 is provided at the air inlet 52 to augment flow, and an air extractor fan 72 is positioned at the end of an extension duct 74 for extracting stale air.

Some form of shut off may be employed in the system so that the backpressure from inside the house does not force the fresh air out of the other fresh air inlets. The shut off can be very light and if the shut off fails, it will fail in an orientation where the predominant wind will continue to drive the system.

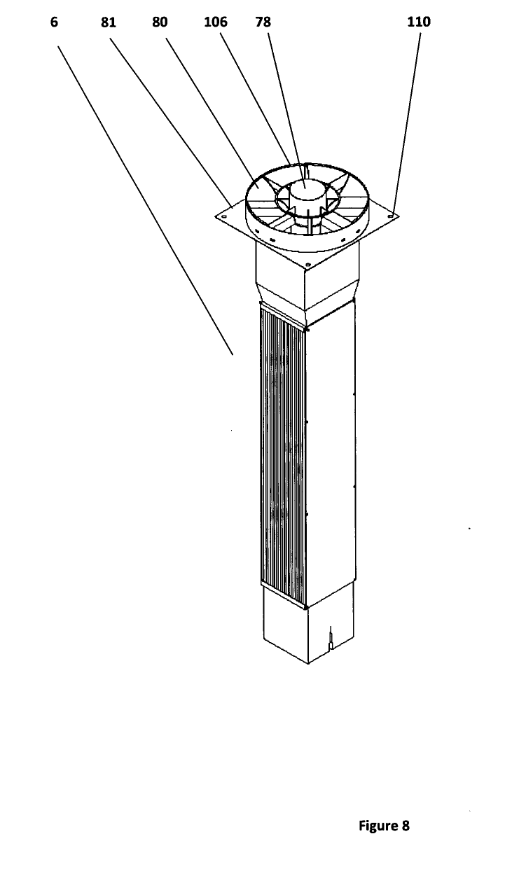

Referring now to the specific construction of device 2, in FIGS. 1, 7 and 8, the lower heat exchanger part 6 has end sections 26, 28 for fitting to ducts within a chimney flue, and which communicate with respective spaces 24, 22 within the heat exchanger 6 at a base region 75, involving selective blocking of the spaces 22, 24. An upper region 76 of the heat exchanger communicates with an inner stale air exit flow path 78, and a surrounding fresh air inlet flow path 80. The spaces 22, 24 of the heat exchanger are selectively blocked in region 76 to permit spaces 22 to communicate with inner flow path 78 and spaces 24 to communicate with outer fresh air path 80. As best seen in FIG. 8, the top of part 6 has an outwardly extending flange 81 for mounting to the top of a chimney stack.

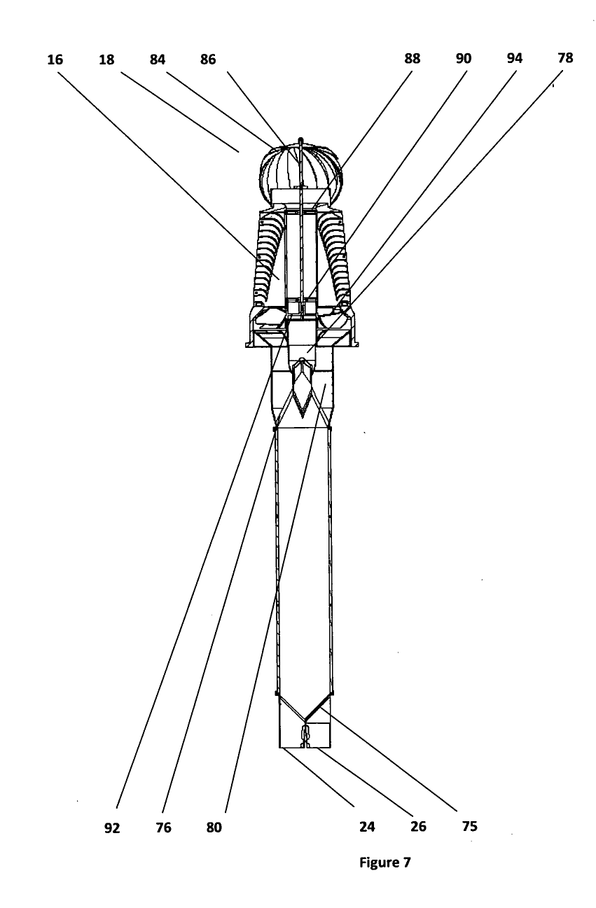

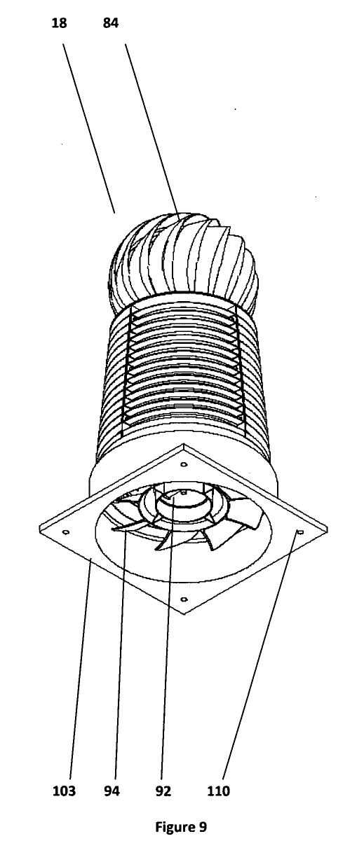

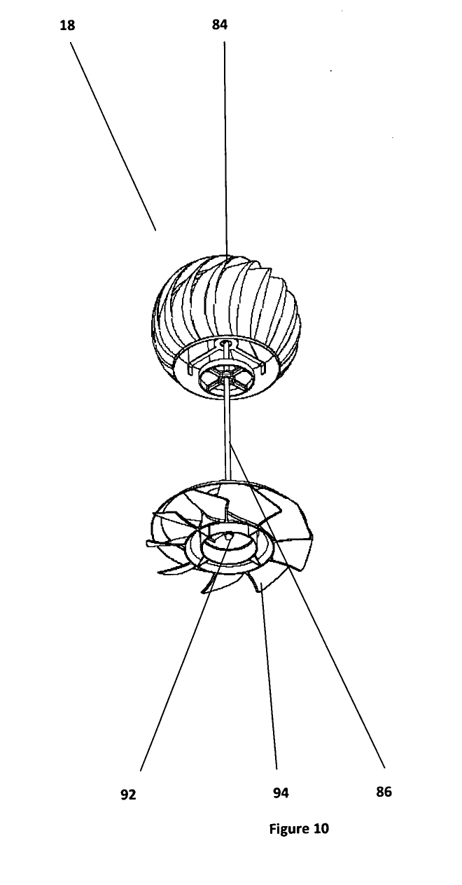

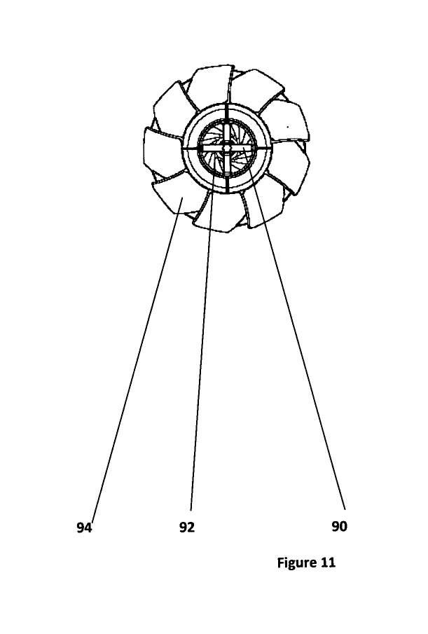

Fresh air flow path 80 communicates with fresh air plenum 16 within air flow part 4. Stale air flow exit flow path 78 continues in air flow part 4 to the top of part 4 where it communicates with turbine ventilator 18 mounted on top of part 4. Turbine ventilator 18 comprises a large number of scoop shaped elements 84 arranged in a circle, and arranged in known manner to rotate in response to external wind from any direction. The ventilator has a long shaft 86 mounted on an upper bearing 88 and extending though flow path 78 to a lower bearing 90 where it is coupled with a fan assembly, (FIGS. 7-11) comprising an inner flow regulator 92 mounted within air flow path 78, and an outer centrifugal fan 94 mounted between fresh air plenum 16 and fresh air path 80.

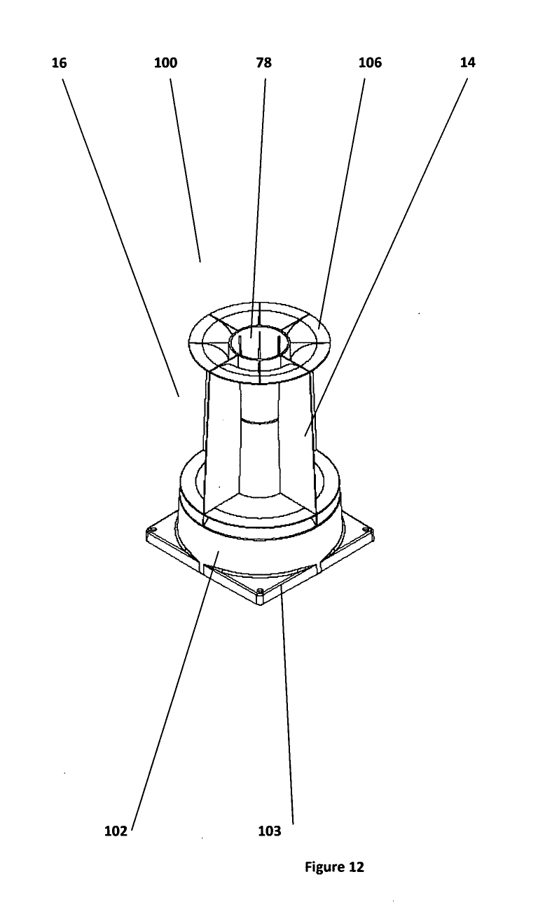

As shown in FIG. 12, an inner cowl 100 within the air flow part 4 serves to define and separate the stale air flow path 78 and the fresh air plenum 16. It provides a housing 102 for the fan assembly and a base flange 103 for registering with flange 81 of heat exchanger part 6. Radial ribs or walls 14 provide supports for louvres 11, which are fitted between the ribs 14. The top part 106 of cowl unit 100 provides a flattened rim area 108 to which the turbine ventilator 18 is secured. As shown in FIG. 8, the top of part 6 has a circular raised portion 108 for registering with base 102 and coupling together the air flow paths of parts 4, 6.

Thus in operation, stale air flow upwardly from ducts, 62 into heat exchanger part 6, where its heat is employed to heat incoming fresh air. The flow of stale air is regulated by the operation of inner fan 92 and turbine ventilator 18, turbine ventilator 18 rotating in response to external wind. For fresh air inflowing through louver apertures 12, the fan 94 operates to boost the pressure of the fresh air flow. Importantly, the combined fan assembly comprising turbine ventilator 82, and fan 94 has an inertia, and acts as a flywheel or “smoothing capacitor” to ensure a reasonably constant air flow both of stale air and fresh air, in the circumstance where external wind flow may be irregular. Fan 94 acts to boost the inlet pressure, balance the flow between the exit and inlet streams and act as a capacitor to smooth the wind intermittency. While the fan 94 is extracting energy from the turbine ventilator, the wind pressure through louvers 12 is still the main flow driver.

For installation, for the most part, the heat exchanger 6 and airflow device 4 are held in place via gravity. In addition, four anchors bolts installed in the chimney top may lock the units by affixing through apertures 110 in flanges 81, 103. A sealing gasket may be compressed between the flanges.

The airflow part 4 will either be made of metal or plastic. The heat exchanger of this second embodiment is made up of a series of channels, separated by aluminium plates. The casing of the heat exchanger is made up of three plastic sections screwed together. The plastic sections hold the aluminium plates. Another way to manufacture the heat exchanger would be to extrude the heat exchanger section out of one piece of aluminium and cap the ends with plastic or steel sections

What is claimed:

1. A passive heat recovery and ventilation device for a passive heat recovery system fitted within a chimney of a building, the device including a heat exchanger part being dimensioned to fit within a chimney flue at the chimney top, and the device including an air flow part for positioning on top of the chimney, which includes an air outlet for exhausting stale air and an air inlet for drawing in fresh ambient air, wherein said air inlet comprises a plurality of louvred air inlets extending around the periphery of the airflow part, and communicating with an interior plenum, and said air outlet includes a turbine rotator mounted at the top of the air flow part,
said air inlet and air outlet communicating with said heat exchanger part for transfer of heat between outlet and inlet air flows, and said heat exchanger part having air flow ports for connection to air flow ducts fitted within the chimney flue.

2. A device according to claim 1, wherein said heat exchanger part includes a heat exchanger comprising an array of parallel plates defining flow paths, wherein adjacent flow paths are arranged to receive respectively fresh air flow and stale air flow.

3. A device according to claim 1, wherein said heat exchanger part has a peripheral flange at its top for seating on the chimney top and for receiving a further peripheral flange of said air flow part, the flanges having registering apertures for receiving fixing bolts.

4. A device according to claim 1, wherein said air flow part has an inner cowl member for defining a tubular flow path of said air outlet, surrounded by said interior plenum.

5. A device according to claim 1, wherein said turbo rotator is coupled by shaft means to a fan located within said air inlet, so as to rotate with the turbine rotator, and to assist flow of inlet air.

6. A device according to claim 5, wherein said fan is located adjacent the base of said airflow part.

7. A device according to claim 5, wherein said fan is one of a centrifugal fan, an axial flow fan, and a mixed-flow fan.

8. A passive heat recovery and ventilation system fitted within a chimney of a building, the system including an inlet flow duct and an outlet flow duct installed within the chimney flue, and extending to the chimney top, and a heat recovery device located at the chimney top including a heat exchanger part located in the chimney flue and having air inlet and air outlet ports communicating with said flow ducts, and including an air flow part positioned on top of the chimney, communicating with said heat exchanger part and providing an air outlet for exhausting stale air and an air inlet for drawing in fresh ambient air.

9. A passive heat recovery and ventilation system according to claim 8, wherein said air inlet comprises a plurality of air inlets, including louver deflectors, extending around the periphery of the airflow part, and communicating with an interior plenum, whereby said louver deflectors and the natural energy of the wind are operative to force fresh air into the interior plenum.

10. A passive heat recovery and ventilation system according to claim 8, wherein said air outlet includes a turbine rotator mounted at the top of the air flow part.

11. A passive heat recovery and ventilation system according to claim 8, wherein said heat recovery device is the passive heat recovery and ventilation device of claim 1.

12. A method of converting an existing chimney of a building into a passive heat recovery and ventilation system, the method comprising:
providing a fresh air outlet in the chimney flue and a stale air inlet in the chimney flue,
inserting first and second ducts within the chimney flue, the first duct extending from the fresh air outlet to the chimney top, and the second duct extending from the stale air inlet to the chimney top,
inserting a passive heat exchanger means in the chimney top and connected with said first and second ducts for transferring heat from stale outgoing air to fresh incoming air, and positioning an air flow means on top of the chimney and communicating with the heat exchanger for exhausting stale air and drawing in ambient air.

13. A ventilator device for an enclosed space, and including an air flow part having an exhaust flow path for exhausting stale air and an inlet flow path for drawing in ambient air, wherein the air flow path includes a turbine rotator, for positioning externally of the enclosed space, and arranged to draw out exhaust air under the influence of external wind, and wherein the turbine rotator is arranged to drive a fan located in the air inlet flow path, for boosting the pressure of the inflow of ambient air.

14. A device according to claim 13, wherein said fan is one of a centrifugal fan, an axial flow fan, and a mixed-flow fan.

15. A device according to claim 13, wherein said turbine rotator is located at a top of said air flow part and is coupled by a shaft to said fan at a base of said air flow part, said shaft extending through a tubular air flow path for stale air, which is surrounded by a plenum for inlet ambient air, and said fan being disposed at the base of said plenum.

16. A device according to claim 15, wherein said air inlet comprises an array of louvred air inlets defining the outer periphery of said plenum.
